(19) United States
(12) Patent Application Publication
(10) Pub. No.: US 2024/0427552 A1
(43) Pub. Date: Dec. 26, 2024

(54) SYSTEM AND METHOD FOR MEASURING EFFECTIVENESS OF ADVERTISEMENT DISPLAYS

(71) Applicants: Yeshaya Krispin, Toms River, NJ (US); Harry Rosenberg, Monsey, NY (US); Shlomo Hayun, Meitar (IL); K & R VENTURES, LLC EIN # 38-3942959, TOMS RIVER, NJ (US)

(72) Inventors: YESHAYA KRISPIN, TOMS RIVER, NJ (US); HARRY ROSENBERG, MONSEY, NY (US); SHLOMO HAYUN, MEITAR (IL)

(21) Appl. No.: 18/823,736

(22) Filed: Sep. 4, 2024

Related U.S. Application Data
(63) Continuation-in-part of application No. 17/676,161, filed on Feb. 20, 2022.
Application No. 17/676,161 is a continuation-in-part of application No. 16/662,056, filed on Oct. 24, 2019, now abandoned.
Application No. 16/662,056 is a continuation-in-part of application No. 16/175,875, filed on Oct. 31, 2018, now Pat. No. 10,922,050.
Application No. 16/175,875 is a continuation of application No. 15/393,292, filed on Dec. 29, 2016, now Pat. No. 10,133,548.
Application No. 15/393,292 is a continuation-in-part of application No. 15/113,831, filed on Jul. 24, 2016, now Pat. No. 10,399,627.
(60) Provisional application No. 63/207,991, filed on Apr. 6, 2021.
(60) Provisional application No. 62/273,480, filed on Dec. 31, 2015.
(60) Provisional application No. 62/075,914, filed on Nov. 6, 2014.
(60) Provisional application No. 61/965,255, filed on Jan. 27, 2014.

(51) Int. Cl. G06F 3/16; B64U 101/31; G01S 19/13; G06F 1/16; G06F 3/048; G08B 5/00; G08B 25/01; H04B 1/3827; H04N 23/63; H04N 23/661; H04W 4/90

(52) U.S. Cl. CPC G06F 3/167; G01S 19/13; G06F 1/163; G08B 5/002; G08B 25/012; G08B 25/016; H04B 1/385; H04N 23/661; H04W 4/90; B64U 2101/31; G06F 3/048; H04N 23/634

(57) ABSTRACT

Systems and methods for measuring effectiveness of advertisement displays in public areas. A smart sensor box is connected to the display screen incorporating cameras to capture images of the vicinity of the display and individuals within it. A location sensor captures the location of the display. A processing unit identifies and profiles individuals viewing the display based on data captured by the cameras and the location sensors. A communication interface transmits processed data to a central hub and receives feedback from the central hub. The central hub analyses display engagement and profiles of individuals for measuring the effectiveness of the advertisement being displayed and provides feedback for updating the display.

### CROSS-REFERENCE TO RELATED APPLICATIONS

This application is a Continuation-In-Part of U.S. patent application Ser. No. 17/676,161, filed Feb. 20, 2022, which claims priority and benefit from U.S. Provisional Patent Application No. 63/207,991, filed Apr. 6, 2021, and which is itself a Continuation-In-Part of U.S. patent application Ser. No. 16/662,056, filed Oct. 24, 2019, which is a Continuation-In-Part of U.S. patent application Ser. No. 16/175,875, filed Oct. 31, 2018, which is a Continuation of U.S. patent application Ser. No. 15/393,292, filed Dec. 29, 2016, which claims priority and benefit from U.S. Provisional Patent Application No. 62/273,480, filed Dec. 31, 2015, and which is a Continuation-In-Part of U.S. patent application Ser. No. 15/113,831, filed Jul. 24, 2016, which is a U.S. National Phase Application under 35 U.S.C. 371 of International Application No. PCT/IB2015/050567, which has an international filing date of Jan. 26, 2015, and which claims priority and benefit from U.S. Provisional Patent Application No. 61/965,255, filed Jan. 27, 2014, and U.S. Provisional Patent Application No. 62/075,914, filed Nov. 6, 2014. The contents and disclosures of the above-identified applications are incorporated herein by reference in their entirety.

### FIELD OF THE INVENTION

The present disclosure relates to public display boards. In particular, the present disclosure relates to systems and methods for determining the effectiveness of the advertisements on the public display boards.

### BACKGROUND OF THE INVENTION

It is often useful to display information to subjects within one's surroundings. As visual displays are particularly good at displaying such information, visual displays may be carried by individuals as they move from location to location. The information may also be displayed to the individuals through roadside display boards, known as signages, may be designed to persuade receivers of the merits of a given product or service.

The information being displayed by such wearable devices may be used to indicate, for example, safety information to other pedestrians of road users, such as alerting them that the wearer is slowing down, speeding up, turning right, turning left or the like. Further, these wearable devices may display location-based advertisements for the offers being offered at the nearby markets, theaters, malls, etc. These devices, worn by the sales agents, present current offers of one or more of nearby vendors to the local people in the market areas or roads.

However, there is no mechanism to measure the effectiveness of these advertisements on the display boards leading to the waste of advertisement resources. Further, these display boards present the advertisement without considering the target viewers. There is no easy way to provide feedback relating to the effectiveness of display advertising. The invention described herein addresses the above-described needs.

### SUMMARY OF THE INVENTION

According to an aspect of the invention, a device for measuring the effectiveness of advertisement being displayed on a display screen placed in a public area is disclosed, wherein the device is connected to the display screen. The device comprises one or more image capturing devices configured to capture images of the vicinity area of the display screen and the individuals in the vicinity area. One or more location sensors are configured to capture the location of the display screen. The device also comprises a processing unit configured to process the data captured by the image capturing devices and the location sensors and a communication interface configured to transmit the processed data to a central hub via a network and receive feedback from the central hub.

As appropriate, the processing unit identifies the individuals viewing the advertisement on the display screen and generate their profiles.

The central hub receives and analyses the processed data for measuring the effectiveness of the advertisement and provides feedback to the device for updating the advertisement on the display screen.

In an exemplary embodiment, the display screen and the device are connected at the back of a bag pack of a sales or delivery person.

In another exemplary embodiment, the display screen and the device are connected at a billboard or a digital display board.

As appropriate, the device and the display screen are connected via wired or wireless medium.

In a further embodiment, the display screen is also configured to display public messages, hazard warnings or announcements to a group of people.

As appropriate, the device may further comprise one or more of a microphone, a speaker, solar panels, rechargeable batteries, a charging and temperature sensor and a USB port.

The processing unit of the device is further configured to identify the number of people in the vicinity of the display screen, determine the facial expressions of the individuals viewing the advertisement on the display screen to determine their interest pattern in an advertised product and measure the duration of advertisement watched by the individuals or any specific portion of the advertisement watched by the individuals on the display screen.

In an alternative embodiment, the device is further configured to send promotional offers to the individuals viewing the advertisement on the display screen.

Additionally, the central hub analyses the data to determine metrics for a costing function of the advertisement based on an expenditure on displaying the advertisement and revenue generated from the display of the advertisement.

Additionally, the metrics is used to determine different business parameters associated with the advertisement and the updating of the advertisement on the display screen is based on the metrics.

In yet another embodiment of the invention, a system for measuring the effectiveness of advertisement is disclosed. The system comprises a display screen placed in a public area configured to display advertisements and promotional offers. A smart box device is detachably connected to the display screen. The smart box device comprises one or more image capturing devices configured to capture images of the vicinity area of the display screen and the individuals in the vicinity area. One or more location sensors are configured to capture the location of the display screen. The smart box device also comprises a processing unit configured to process the data captured by the image capturing devices and the location sensors and a communication interface.

The system further comprises a central hub connected to the smart box device through a network. The central hub comprises a data receiver configured to receive the processed data from the smart box device. An analysis module is configured to analyze the processed data for measuring the effectiveness of the advertisement being displayed on the display screen and generating feedback for updating the advertisement on the display screen and a delivery database is configured to store the analyzed data and the generated feedback and transmitting the feedback to the display screen for running the advertisement.

In a further embodiment of the invention, a method for measuring the effectiveness of advertisement being displayed on a display screen placed in a public area is disclosed. The method comprises the steps of connecting a smart box device to the display screen, capturing images of the vicinity area of the display screen and the individuals in the vicinity area through one or more image capturing devices of the smart box device and capturing location of the display screen through one or more location sensors of the smart box device. The method further comprises monitoring engagement of individuals with the display screen by identifying the individuals viewing the advertisement being displayed on the display screen, generating profiles of the individuals viewing the advertisement, analyzing the engagement of individuals with the display screen and the generated profiles for measuring the effectiveness of the advertisement being displayed and running the advertisement on the display screen based on the measured effectiveness.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 illustrates a personal display system including a wearable display device designed for securing a rider of an open vehicle;

FIG. 2 illustrates a possible system architecture of various system components for providing automatic signaling for a user of a wearable display;

FIG. 3 is a flowchart illustrating a method for automatically presenting information visually to third parties;

FIG. 4A illustrates a signaling mechanism of the personal security platform;

FIG. 4B illustrates a grid of indicators arrangement of the signaling mechanism as illustrated in FIG. 6A as a grid constituting pixels, with a controller being configured to selectively activate only those indicators required to produce the required signal;

FIG. 5A schematically represents a delivery agent, wearing a delivery monitor, collecting a goods package from a first party and delivering the goods package to a second party;

FIG. 5B schematically represents a delivery monitoring system according to aspects of the current disclosure; and

FIG. 6A illustrates a possible system architecture of the personal security platform presenting the various system components and modules of the personal security platform;

FIG. 6B illustrates the activation mechanism of the personal security platform configured to provide automatic, manual and voice activation methods;

FIG. 7A illustrates a method used by the personal security platform to control at least one protecting agent such as a UAV as indicated in FIG. 1A;

FIG. 7B illustrates a method whereby the personal security platform is operable to monitor input of at least one platform component as indicated in FIG. 1A;

FIG. 8 illustrates a method used in the personal security platform for indicating a turn signal;

FIG. 9 illustrates a method used in the personal security platform for indicating a warning;

FIG. 10 which illustrates a system to measure and increase the effectiveness of the advertisements on a display device using a smart sensor box;

FIG. 11 illustrates various exemplary components of the smart sensor box;

FIG. 12 illustrates an exemplary marketplace area with the display device attached on the back of the bag pack of a sales person;

FIG. 13 illustrated an exemplary shopping mall area with the display device placed outside a store;

FIG. 14A illustrates the display device on the back of a bag pack with the smart sensor box attached to the bag pack;

FIG. 14B illustrates the display device on a vehicle with the smart sensor box attached to the vehicle; and

FIGS. 15A and 15B provide a flowchart illustrating a method for measuring the effectiveness of advertisements and promotional offers on a display.

### DETAILED DESCRIPTION

The disclosure relates to systems and methods for a personal wearable mobile display unit which may provide location based visual presenation. For example a display may be used to present a location sensitive notification such as a hazzard warning, an advertisement, a signaling system operable to provide automatic signaling for a user of an open vehicle, local information and the like.

A wearable item such as a jacket, backpack, helment or the like, may include a command signal generating unit configured to generate at least one command signal for controlling at least one display unit such as a rear-facing display visible for an observer behind the user when wearing the wearable item. The rear-facing display may include one or more indicators, and the rear-facing display is operable to receive at least one command signal thereby controlling each of the indicators according to command signal.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

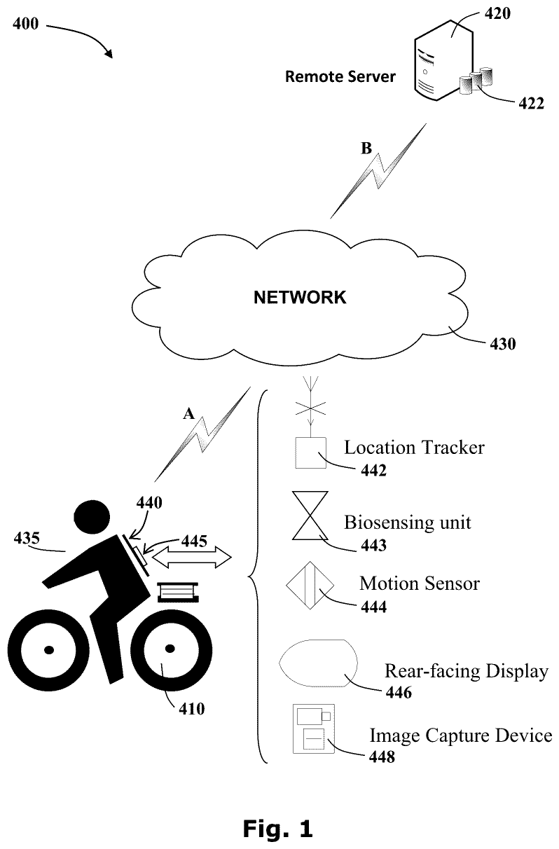

Reference is now made to FIG. 1, there is provided another personal display system, which is generally indicated at 400, including a wearable display worn by a rider of an open vehicle. The personal display system 400 comprises a wearable item 440 worn by a user 435 riding an open vehicle 410, the wearable item 440 comprising a command signal generating unit 445 operable to communicate with signaling agents and system components to provide automatic displays and further to communicate with a remote server 420 through network 430 and communication channel “A”.

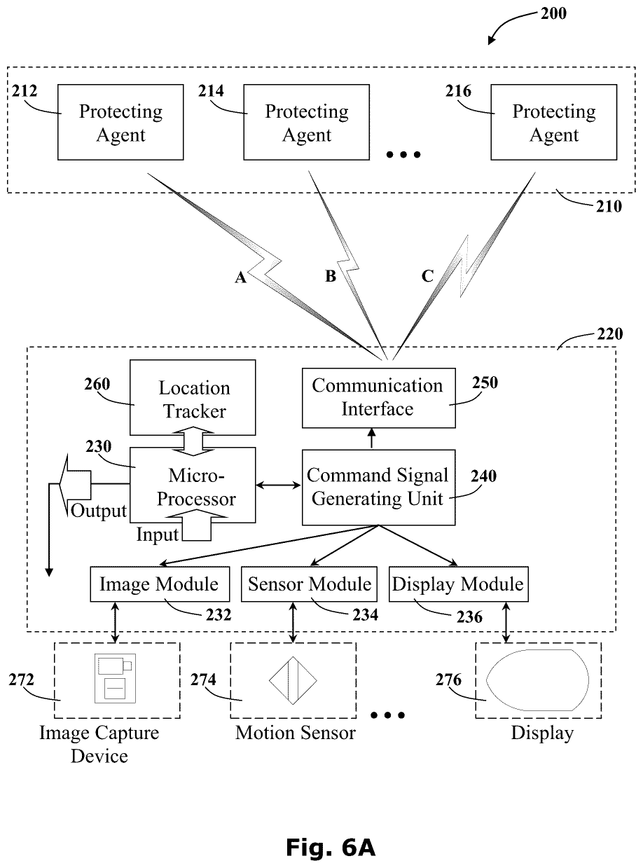

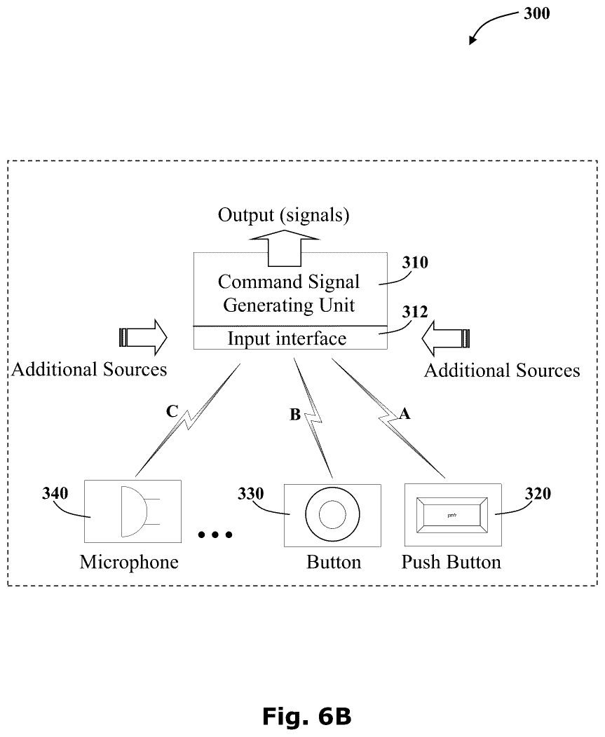

The wearable item 440 further comprises a display module comprising a rear-facing display 446 visible for an observer behind the user 435 when wearing the wearable item 442, where the rear-facing display 446 includes one or more indicators. The rear-facing display 446 is operable to receive at least one command signal from the command signal generating unit 445 thereby controlling each of the indicators (see FIG. 6A) according to signal commands.

Optionally, the display module comprises a front-facing display facing ahead towards the direction of motion and visible to observers ahead of the user 435.

The system 400 further comprises a location tracker module 442 for mapping and tracking a location. It is a particular feature of the invention that data from the location tracker module 442 is used by a microprocessor to determine a required visual presentation to be displayed on the display device of the wearable item.

The system 400 may further include a biosensing unit 443, a motion sensor module 444 for providing at least one motion parameter associated with the open vehicle 410 and an image capturing module 448 comprising at least one camera operable to provide at least one captured image, wherein the camera may be one or more of a front camera, a back camera and a side camera. All such units may further provide inputs to the microprocessor for determining a required visual presentation to be displayed.

It is noted that biosensing unit may comprise at least one biometric sensor such as selected from a group consisting of a pulse monitor; a breath monitor and the like as well as combinations thereof. For example a pulse sensor may be introduced near the wrist of a sleeve of the wearable item. Accordingly, in the event of accident, the display may be configured to display vital signs to emergency service providers attending the wearers.

Additionally or alternatively, the at least one personal protecting agent comprises at least one life support system. Optionally, the life support system comprises an air delivery system. Where appropriate, the at least one life support system may be configured and operable to actively heat the subject. Optionally, again, the at least one personal protecting agent may comprise a defibrillator which may be automatically triggered by a life support system when no pulse is detected.

Accordingly, a method is taught for protecting a subject via automatic security measures. The method may include providing a personal security platform, detecting an emergency event; and triggering at least one personal protecting agent. The method may further include monitoring biometric signals of the subject, delivering air to the subject, actively heating the subject, monitoring biometric signals of the subject, triggering a life support system and releasing a trace-color into the surrounding environment thereby rendering the subject visible to rescuers.

It is further noted that life support may be provided by tubing or air vents/air holes may be provided enabling the circulation of hot/warm air to keep the wearer warm. If he is under snow, this system may further be used to help to melt surrounding area to allow for air flow as well as to provide warmth.

Herein, the term “open vehicle” is used to denote a motorcycle, moped, motor scooter, manual or powered bicycle, or any other mode of transportation wherein a rider's upper body is exposed and readily visible to other travelers on the road.

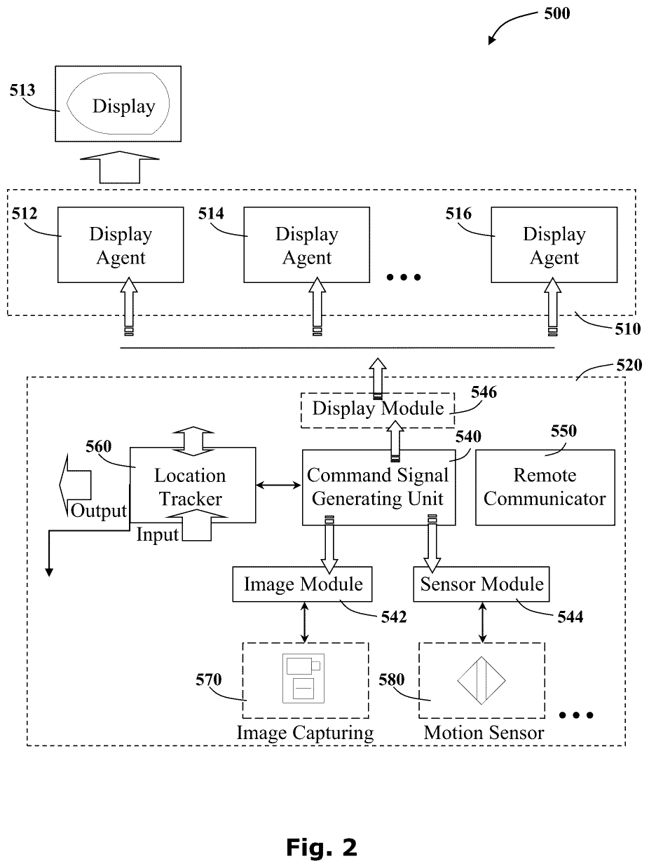

Reference is now made to FIG. 2, there is provided another possible system architecture of a personal security platform, which is generally indicated at 500, the architecture presents the various system components of the personal security platform for providing a signaling system operable to provide automatic signaling for a user of an open vehicle.

The personal security platform architecture 500 comprises a wearable item 520 operable to control at least one set 510 of signaling agents such as a first display agent 512, a second display agent 514 and a third display agent 516 in communication with a display 513.

It is noted that the display agents 512, 514 and 516 are presented as an example only and is intended to specify one or more protecting agents.

The wearable item 520 is configured to be worn by the user (FIG. 1, item 440) or attached to his garment, and comprises a command signal generating unit 540, a remote communicator unit 550, a location tracker 560, an image module 542 and a sensor module 544.

The command signal generating unit 540 is configured to generate at least one command signal for controlling at least one display agent. The command signal generating unit 540 may receive input from the location tracker 560, the communication unit 550 and various component modules. Based upon input from these units, the command signal generating unit 540 may select the required presentation to be displayed and the display module 546 may instruct the display agents accordingly.

The component modules associated with the platform, such as an image module 542 configured to manage an image capturing device 570, a sensor module 544 configured to manage at least one motion sensor 544, a display module 546 configured to manage a signaling agent of at least one display.

The remote communicator unit 550 may provide the communication channel to a remote server. Accordingly, the remote communicator unit 550 may receive instructions from the remote server to display, for example, location specific information in real time. Accordingly, a time and location sensitive advert may be displayed at the required time and place. By way of example, during a vaccine drive, a clinic may be able to notify nearby people that spare vaccines are available before they expire and are destroyed, similarly, restaurants or other food providers may be able to advertise for those nearby to receive items at reduced rates before they expire.

It is further noted that data collected by the image capturing device 570, location tracker 560 and sensor modules 544 may provide information pertaining to the actions and habits of the user. Accordingly, targeted messaging may be provided to the wearer themselves, either via an output of the wearable item 520 or via an external communication device such as a smartphone, or a wearable display worn by a third party within the vicinity.

For example, data may be gathered by sensors of the wearable device which indicate, for example, that the wearer tends to order a salad for lunch at a certain time. Such information may be combined with the position of the user and provided local eateries or salad bars in the vicinity of the user. Targeted messages may be sent to the user by local eateries offering salads possibly at discounted rates. Where multiple users are close to each other, such targeted messages may be sent directly to the user, for example, by displaying an advert on a third party wearable display directly within the eyeline of the user.

Additionally or alternatively, the consumer, may initiate the targeted messaging by logging in to a directory of local eateries to see if there are any local places that have their preferred options.

It will be appreciated that such targeted messaging may be manual or automatically managed for example using artificial intelligence or any other appropriate algorithm.

In still other embodiments, image capturing devices may be used to monitor delivery of a product, for example temperature of a pizza may be monitored upon delivery so as provide quality management feedback to the supplier. Still further data may be captured and utilized for improving transactions, such as capturing the transaction process to insure proper allocation of the orders.

It will be appreciated that the remote communicator unit 550 may further provide a communication channel to the remote server, for example to update a central manager with information of the movements of the wearer, or to alert emergency services in the even of an accident.

The display module 546 may control a display agent comprising a rear-facing display attached to the back of the user (FIG. 1, item 435) or a front-facing display attached to the user (FIG. 1, item 435) at the front or both.

The sensor module 544 is configured to determine at least one motion parameter associated with the user (FIG. 1, item 435) of the open vehicle (FIG. 1, item 410) and may be one or more of an accelerometer, a tilt sensor and a proximity sensor.

The image capturing module 542 is operable to control at least one camera that may be selected from a group of cameras consisting of a front camera, a back camera, a side camera and combinations thereof.

Accordingly, the command signal generating unit 540 is configured to generate at least one command signal to allow communication for controlling at least one signaling agent such as a display agent 512, a display agent 514 and a display agent.

The personal security platform architecture may further include a location tracker module 560 for tracking a location of the user, and the location tracker module 560 is configured to provide location based data to the command signal generating unit.

Optionally, the wearable item 520 comprises the location tracker module 560. Additionally, the wearable item 520 is configured to retrieve map data from an external source, based on data from the location tracking module 560.

Optionally, the location tracker module 560 comprises a satellite navigation system. As appropriate, the location tracker module 560 is configured to communicate with an external satellite navigation system.

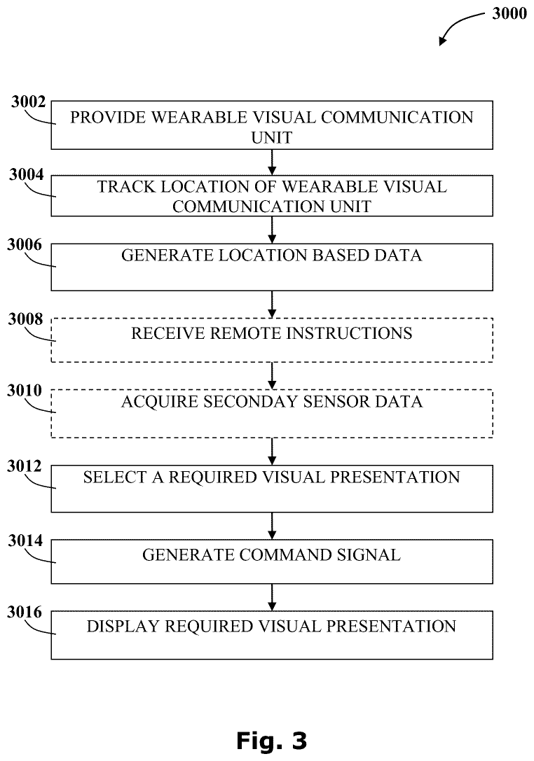

Reference is now made to the flowchart of FIG. 3 which represents a method 3000 for automatically presenting information visually to third parties. The method includes providing a wearable visual communications unit 3002, tracking the location of the wearable visual communication 3004, generating location-based data 3006, selecting a required visual presentation 3012, generating a command signal to control the visual display 3014 and presenting the required visual presentation on the display 3016.

Optionally, the remote communicator may receive remote instructions 3008. Similarly, the command signal generating unit may further acquire secondary sensor data 3010 such as from biometric sensors, movement sensors, and the like.

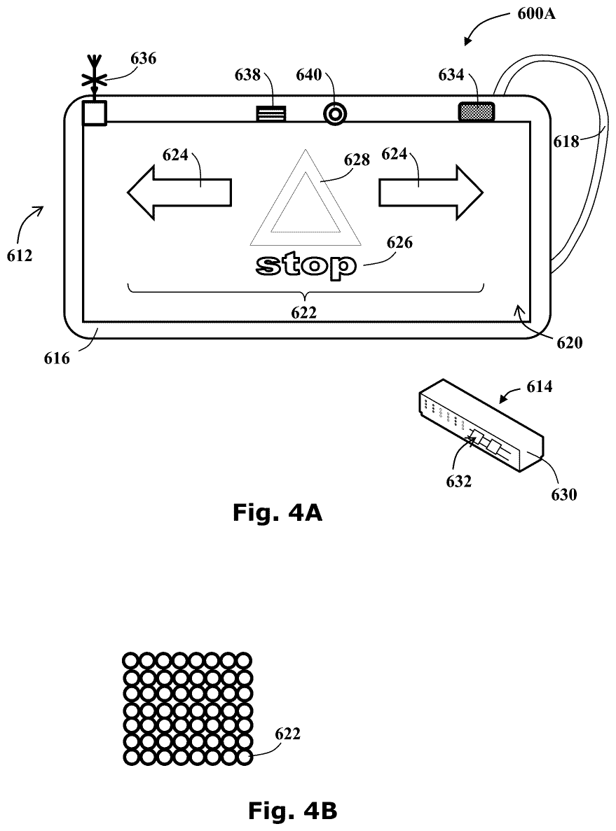

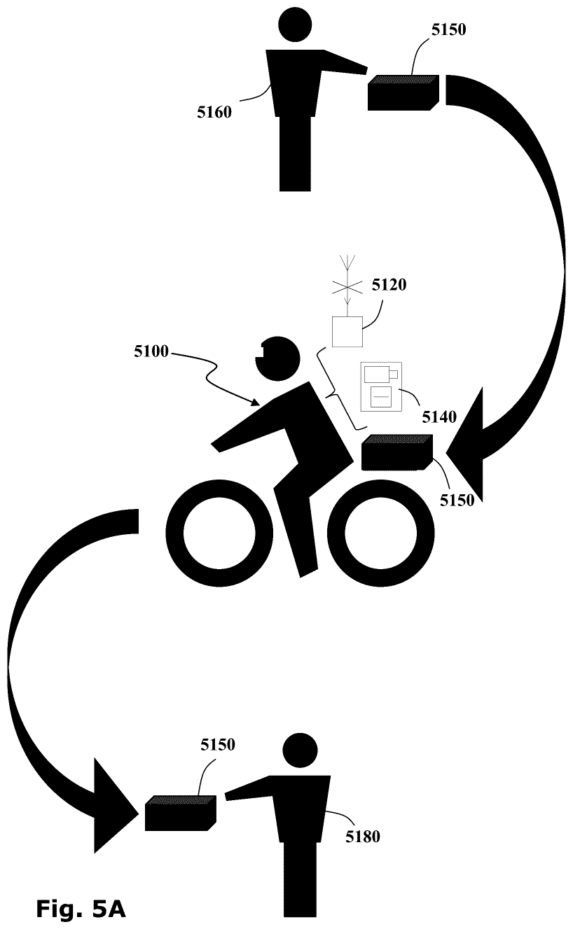

Reference is now made to FIG. 4A, there is provided a signaling mechanism of the personal security platform, which is generally indicated at 600A, designed for use by a rider of an open vehicle. Herein the specification and claims, the term “open vehicle” is used to denote a motorcycle, moped, motor scooter, manual, powered bicycle, skis, snowboard, sledge or any other mode of transportation wherein items worn by rider are exposed and readily visible to other surrounding viewers. The system 600 comprises a wearable item 612, a control interface 614, and a controller.

The wearable item 612 is configured to be worn by a user, and thus comprises a rear panel 616 and a carrying arrangement 618. The carrying arrangement 618 is configured to cooperate with the rear panel 616 to facilitate wearing the vest 612 such that when worn by a user, the rear panel 616 lays across the user's back, and is visible to an observer therebehind.

The carrying arrangement 618 may comprise a pair of straps, as illustrated. Alternatively, it may comprise any suitable arrangement to facilitate wearing the vest 612 as described above. According to one example, the carrying arrangement 18 may comprise a pair of front panels attached to bottom edges of the rear panel 616, giving rise to a pair of armholes. According to another example, the carrying arrangement 618 may comprise a single front panel attached to the rear panel 16 at two ends of a top edge thereof, giving rise to a neckhole, and being open at the sides.

The rear panel 616 comprises a rear-facing display 620 (i.e., disposed so as to be visible from an observer behind the user when wearing the vest 612), comprising one or more indicators, which are generally indicated at 622, thereon. The indicators 622 may be illuminative, for example comprising one or more light emitting diodes (LEDs). The controller is configured to operate the indicators 622 to produce signals signifying information about the user, in particular relating to parameters of the drive. According to some modifications, the display comprises a flexible screen, for example comprising organic light-emitting diodes (OLEDs), or any other suitable technology.

For example, one or more of the indicators 622 may be configured to signify that the user is about to or is in the middle of executing a right or left turn (i.e., constituting turn signals 624); one or more of the indicators 622 may be configured to signify that the user is in the middle of slowing down (i.e., constituting a brake light 626); one or more of the indicators 622 may be configured to signify a hazard such as a the vehicle being stopped in or near moving traffic, that the vehicle is disabled, that a vehicle is moving substantially slower than the flow of traffic, etc. (i.e., constituting a hazard warning light 628, which may be constantly illuminated or be flashing). It will be appreciated that the indicators 622 may be configured to display any other suitable message, mutatis mutandis.

According to some examples, as illustrated in FIG. 4B, the indicators 622 are arranged as a grid constituting pixels, with the controller being configured to selectively activate only those indicators required to produce the required signal. According to other examples, for example as illustrated in FIG. 6A, the indicators 622 comprise preformed signals, for example comprising LED strips, with the control being configured to selectively activate a required indicator to illuminate the required signal.

The control interface 614 is configured to facilitate the user to communicate with the vest 612, e.g., via the controller. It comprises a housing 630, which may contain the controller therein, and one or more user input devices 632. The user input devices 632 are configured to allow the user to indicate to the controller the type of signal to be displayed by the indicators 622 on the rear panel 616 of the vest. It may comprise, e.g., one or more switches, buttons, dials, etc., each of which (or positions of which) correspond to a different signal to be displayed by the indicators (e.g., turn signals, hazard warning lights, etc.).

According to some modifications, some or all of the user input devices 632 may be integrated into the vehicle, e.g., to be automatically activated during use of the vehicle. For example, for vehicles with integrated turn signals, user input devices 632 may be mounted to the vehicle such that when the user operates the vehicle turn signal, the user input device 632 is automatically operated. This may be accomplished mechanically (e.g., by positioning the user input device of the signaling system 600A such that movement of an element which operates the turn signal also operates the user input device), electrically (e.g., by wiring the user input device of the signaling system 600A to monitor an electrical signal which operates the turn signal of the vehicle, and to operate the indicators 622 accordingly), visually (i.e., by mounting cameras to monitor to turn signals of the vehicle, and operate the indicators 622 accordingly), or according to any other suitable method.

It will be appreciated that while the above example related to the turn signal of the vehicle, the user input device 632 may be similarly integrated to be automatically activated during use of the vehicle, mutatis mutandis. For example, a user input device may be situated so as to be activated by application of a brake pedal or grip, etc.

The control interface 614 is configured to communicate with the vest 612, e.g., the display 620 thereof, via any suitable method. According to some examples, they communicate wirelessly with each other, for example using one or more of a local area network, radio, Bluetooth, ZigBee, Near Field Communication, or any other suitable technology for facilitating wireless communication. A transmitter (not illustrated) may be integrated with the controller, and a receiver 634 provided on the vest 612 in communication with the display.

According to some modifications, the signaling system 600A does not comprises a dedicated control interface 614 and/or controller. Rather, the vest 612 (and elements thereof) is configured to communicate directly with a third-party device, such as a telephone (e.g., a mobile phone with advanced computing capabilities, herein “smartphone”) or any other suitable electronic device (such as a pocket-sized computer, for example as marketed under the trade name “iPod®” by Apple Inc.). The device may be configured (e.g., by installing an application thereon) to receive user input (e.g., by visually sensing hand motions, by presenting a simulated control interface, etc.) and communicate a command to the vest 612 to operate the indicators 622 accordingly.

According to some examples, the device may be an optical head-mounted display.

According to the above, the device constitutes both the control interface 614 and controller of the signaling system 600A.

The vest 612 may comprise a location tracker module 636, configured to determine the current location of the vest (and thus the user) in real time by communicating with the satellite navigation system (such as the Global Positioning System (GPS) satellite network or the like). According to some examples, the module may be provided with local street maps, for example via map data being loaded into a memory module thereof. According to other examples, the vest 612 may communicate location information determined by the satellite navigation system to a device (such as a smartphone, pocket-sized computer, etc.) which provides relevant map data thereto, e.g., based on the determined location. The signaling system 600A may provide this information to a remote party, e.g., to track the user. This may be useful for facilitating a business to track a fleet of delivery vehicles, for enabling a parent or guardian to locate a child, etc. An alarm 638, which may produce one or more of an audio and a visual signal, may be activated if a user goes beyond a predefined area.

It will be appreciated that while the vest 612 is described above as comprising a satellite navigation system module 636, the satellite navigation system module may be part of a separate unit configured to communicate therewith, including, but not limited to, a smartphone, a head-mounted display, a dedicated satellite navigation system module, the controller, etc., without departing from the scope of the presently disclosed subject matter.

Location tracking data may be used to compare the speed of the vehicle to the speed of surrounding traffic, for example based on internet-based real time traffic information. If the controller determines, based on the location tracking data and traffic information received, that the vehicle is moving at a speed which is significantly lower than that of surrounding traffic (e.g., a predetermined percentage or net speed amount lower), it may automatically activate the indicators 622 to display a hazard warning light 28 Similarly, location tracking data may be used to automatically detect if the vehicle is slowing down, wherein the controller may activate the indicators 622 to display a brake light 626.

The signaling system 600A may comprise one or more motion sensors (e.g., an accelerometer, tilt sensor, etc., not illustrated) configured to determine parameters of the motion of the vehicle. These parameters may include, but are not limited to, turning, braking, driving speed, etc. The signaling system 600A may thus be configured to automatically activate the indicators 622 to display a suitable signal.

For example, if the motion sensors determine that the vehicle is turning, it may automatically activate the indicators 622 to display a turn signal 624. This function may be integrated with location tracking data. Based on the determined location of the vehicle and corresponding map data, the signaling system 600A may be configured to determine whether a detected vehicle turn is a turn which should be indicated (for example turning onto a side street) or is a turn which should not be indicated (for example following the topography of a curved road). The signaling system 600A may thus be configured to activate appropriate indicators 622 based on both determinations made by the motion sensors and location tracking data. For example, the indicators may display a turn signal 624 when a vehicle turn is detected by the motion sensors, and the location tracking data suggests that a turn should be indicated. The controller may employ one or more heuristic algorithms to make the determination.

By using data from both motion sensors and location sensors, the signaling system 600A may be configured to automatically display a signal faster and/or more accurately than it would be able to be based only on one thereof. In addition to the example provided above with respect to a turn signal, the determination of vehicle speed (i.e., to automatically activate the indicators 622 to display a brake light 626 and/or hazard warning light 28, as described above) may be supplemented with data from the motion sensors.

The controller maybe configured, based on one or more of location tracking data and data from the motion sensors, to determine if an emergency (such as a collision) has occurred. It may further be configured to send out one or more appropriate distress signals, such as communicating with emergency services, sending a message to one or more predetermined contacts (such as a parent, etc.). The signaling system 600A may be configured to interface with a mobile telephone for this purpose.

The vest 612 may further comprise one or more cameras 640 on the rear panel 616, disposed so as to image the area behind the user when wearing the vest. Image data may be recorded and/or communicated to a display unit mounted on the vehicle in front of the user. The display unit may be a dedicated device, or a suitably-configured (e.g., by installation of an application thereon) smartphone and/or pocket-sized computer. The signaling system 600A may thus be used to provide a rear-view to a user when operating his vehicle. This data may be selectively communicated to one or more predetermined contacts of the user.

The signaling system may be configured to automatically archive, either locally or on a remote server accessed wirelessly, visual data recorded by the cameras 640. This may be done automatically, or be event-driven (i.e., in case of an accident).

In addition, the camera 640 may be configured to be used to enable the system 600A to detect and alert vehicles behind the user if they are approaching too closely or too quickly.

According to one example, image data captured by the camera 640 may be used by the controller to determine relative speed of a vehicle approaching from behind the user. This may be accomplished, e.g., by analyzing the image data to detect objects, determining an object to be an approaching vehicle, and tracking the relative size of the object compared to the size of the same object captured in previous frames. Thus, the system 600A may determine if a vehicle approaching from behind is accelerating or maintaining its speed when it should be slowing down, etc.

According to another example, image data captured by the camera 640 may be used by the controller to determine the distance of a vehicle behind the user. This may be accomplished, e.g., by analyzing the image data and comparing it to objects of known sizes. For example, the controller may be preloaded with information related to the size of one or more features of vehicles, such as the size of license plates, the distance between outer edges of headlights (which may be, e.g., typical distances for most cars, distances for particular models of cars which may be determined based on recognizing the front of the car, etc.), or any other suitable value. The controller may thus be configured to determine the distance by comparing the apparent size of the feature captured by the camera to the known size thereof.

The system 600A may be further configured to be used as a social media device. For example, it may be configured to share images captured by the camera 640 on one or more social media networks. It will be appreciated that the “sharing on a social media network” as used herein the specification and claims includes, but is not limited to, posting on an online social media platform such that it can be accessed by anyone with access to the platform or by a predefined set of users, forwarding to a predefined set of contacts, for example via electronic mail, texting agent, Short Message Service (SMS) or Multimedia Message Service (MMS) message, or any other similar medium. Additionally or alternatively, the system may be configured to share the location of the system 600A on a social media network.

The location may be shared alone (e.g., as location tracking data, such as location tracking coordinates), or in conjunction with other information. The information may include, but is not limited to, a shared image, location information (e.g., a landmark, business, or other location in the vicinity of the shared location; it will be appreciated that the location may be shared with the location information, or the location information may be shared as the location), or any other suitable information.

The system 600A may be further configured to be used to report emergency information. For example, it may be configured to facilitate a user's inputting a report of an emergency and transmitting the emergency to the relevant emergency service (e.g., an emergency telephone number such as 911, 112, or 999, fire, police, or first aid services, an online emergency reporting service, etc.). It may further or alternatively be configured to automatically detect an emergency situation, for example by sensing disturbances to the vest (e.g., via the motion sensors), using image recognition of images captured via the camera 640, etc. The emergency information may include, but is not limited to, one or more of location, type of emergency, and images.

Further, the wearable may incorporate biometric sensors operable to monitor the vital signs or the wearer, Accordingly, the emergency information may include the biometric data. Additionally, or alternatively, biometric data may be displayed upon the display for use by those providing medical attention at the site of an emergency.

According to any one of the above examples, the controller may be configured, if it determines that a vehicle approaching from behind is too close or approaching too quickly, to activate one or more of the indicators 622 to display an appropriate warning to the vehicle.

The display may be further configured to display advertisement information. The information may be predetermined. According to some modifications, the controller may use GPS data to select and/or determine advertising information for display. For example, the signaling system 600A may be configured to display information relating to a business (e.g., a theater, restaurant, etc.) when the user is within a predetermined radius thereto. The signaling system may be further configured to display emergency information provided, e.g., by government agencies.

For example, in one embodiment, a display device may notify locals or those in specified areas of time and location sensitive information such as a sale or discount of food establishments that want to sell off or donate or sell at reduced prices any left over foods, or closing specials.

Third parties may be able to upload what they have, their location, which may be indicated by an icon or other indicator on devices worn by individuals in the local area. Such an application could specify any specific location which may be busier, and even in realtime, get updates for example but not limited to, traffic in a certain area, and a local pizzeria may flash a deal for pizza so people would be able to see options, specials in real time. This could be promoted via proprietor's own input, Artificial intelligence, Machine Learning or other updating. This would save food establishments from throwing away unused or unwanted food and help those in need or able to take advantage of specials. This can be used interface to interface. For example, two back packs can play or interact between themselves, either as a base or intermediary.

The platform, as described hereinabove may be used to facilitate execution of one or more methods associated with required to safety and security measures for a user.

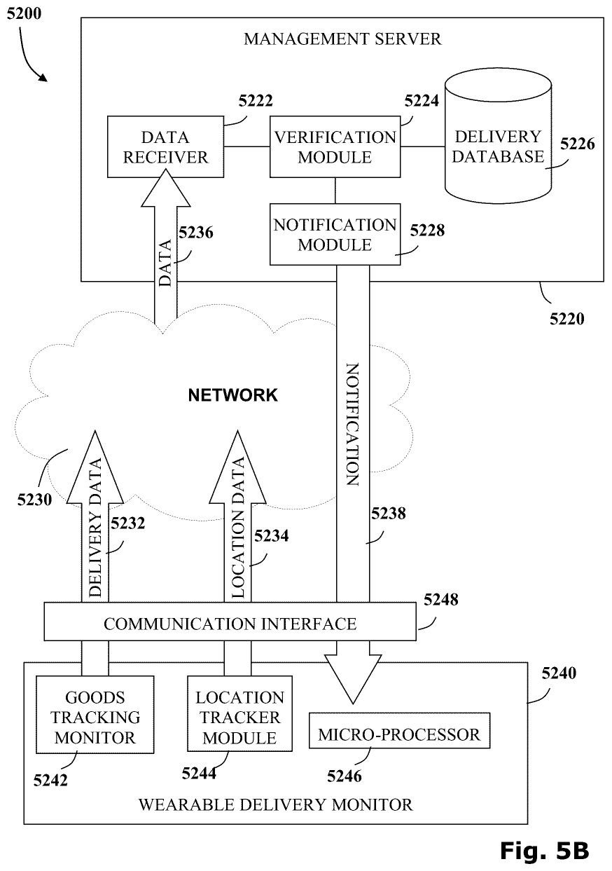

Referring now to FIG. 5A, a delivery agent wearing a wearable delivery monitor 5100 may deliver a goods package 5150 from a first party 5160 to a second party 5180. The wearable delivery monitor 5100 includes a location tracker 5120 and a goods tracking monitor 5140. The delivery monitor 5100 may be used for recording the transfer of goods at either or both of the collection point and the delivery point.

It is noted that a monitor 5140, such as a video camera or the like, may be integrated into an item of clothing. The item of clothing, such as a jacket, coat, helmet, hat spectacles, pants, bag, backpack, watch, shoe or the like as well as combinations thereof may be worn by a delivery agent. The monitor 5140 may further be in communication with a location tracker 5120 such as included in the platform described in U.S. patent application Ser. No. 15/113,831 and U.S. Pat. No. 10,133,548 which are incorporated herein in their entirety.

Accordingly, the wearable item 5100 may locate the delivery agent and the monitor 5120 and may be automatically triggered to record data upon collection and delivery of the goods 5150 for example when the delivery worker arrives at the delivery address. A camera may record the whole process of delivery or collection as a video which may be used to confirm delivery or collection and to indicate the location of the delivery if required.

Where appropriate the recorded data may be processed and sent to the delivery company and/or the customer as required. In particular where nobody is available to receive the delivered item, automatically captured video data may be used to provide evidence of such.

Referring now to FIG. 5B, a delivery monitoring system 5200 may further include a delivery monitor 5240 integrated into a wearable item and a management server 5220 connected via a communication channel such as a computer network 5230.

The wearable delivery monitoring system 5240 includes a goods tracking monitor 5242, a location tracker 5244 and a micro-processor 5246. The system 5240 is in communication with the management system via a communication interface 5248.

The location tracker module 5244, such as a satellite navigation unit, a cellular network or the like, is operable to track the current location of the wearable item 5240. The location tracker module 5244 is configured to provide location based data which is communicated to the management server.

The goods tracking monitor 5242 is operable to record and confirm delivery of goods being delivered. The goods tracking monitor 5242 is configured to provide delivery data. For example, the goods tracking monitor 5242 may comprise a scanner or a camera or the like.

The micro-processor 5246 is operable to coordinate and control the delivery monitor 5240.

The management server 5220 includes a data receiver 5222, a verification module 224 in communication with a delivery database 5226 and a notification module 5228.

The delivery database 5226 is configured and operable to store data pertaining to required deliveries.

The data receiver 5222 is configured and operable to receive goods data 5236 including the location based data 5234 from the location tracker 5244 and delivery data 5232 from the goods tracking monitor 5242.

The verification module 5224 is configured and operable to compare data 5236 received by the data receiver 5222 with data stored in the delivery database 5226. Optionally, the delivery management server 5220 further comprises a notification module 5228 operable to communicate notifications 5228 to the delivery agent via the delivery monitor 5240.

Various features of the system may enable more efficient and secure transfer of goods by monitoring both the collection and delivery of those goods. For example, the camera may be operable to identify or scan a code, such as an alphanumeric code, a bar code, a QR code or the like, which may be included with the item to be delivered, possibly using an integrated image recognition mechanism. Accordingly, the monitor may use the code to confirm that the corresponding items are delivered to the correct delivery address or receiver.

A communication manager may be operable to ensure that data, such as image data, location data, identification data and combinations thereof, may be communicated via a communication agent in real time to the delivery company which may automatically or manually confirm delivery details with the details stored on a delivery management server or database. The system may send a confirmation notification to the delivery agent to continue to the next delivery address. Additionally or alternatively if the recorded monitor data do not match the stored details, a corrective instruction or query may be sent to the delivery agent. Where required, a delivery worker may be prompted to contact a delivery manager for clarification before proceeding to the next delivery.

In other aspects the disclosure teaches a method for efficient and safe dispensing and delivery of prescription drugs. A pharmacy or drug dispenser may send prescription drugs using a delivery agent, such as an external delivery service provider.

Using a delivery monitoring system such as described herein, the delivery may be confirmed to be to the correct destination and even to the correct individual to be receiving the drugs.

A delivery agent collecting the drugs from a pharmaceutical supplier may perform a collection protocol including video comparison between the collected package and the original prescription issued by a medical practitioner to a patient according to local regulations. Such a confirmation mechanism may allow the prescription medicines to be validated and confirmed upon the point of collection such that any discrepancies or inaccuracies may be identified in real time at the point of collection. Where required, a request for clarification or query may be sent to the medical practitioner, who may authorize the amended instructions.

The wearable display may be incorporated into a personal security platform operable to provide automatic security measures and help if facing hostility, aggression, harassment, or any other emergency situation, mostly while in an outdoor activity such as biking, jogging, walking, usage of any open vehicle and the like. The platform comprises a wearable item worn by a user comprising a micro-processor (not shown) and a command signal generating unit configured to generate at least one command signal communicated via the communication network using the communication interface for controlling at least one protecting agent. The command signal generating unit may be further operable to communicate command signals to a remote server via the communication network comprising relevant data messages.

It is noted that the wearable item may be a device, a token and the like attached to the user garment.

It is also noted that the personal security platform is configured to be activated automatically upon identifying an alerting condition, or manually by pressing a button or by pulling a cord, for example, or may be voice activated.

It is specifically noted that in addition, the personal security platform is operable to provide various technical features, as described hereinafter. The platform, using wearable technology, may include controllable high visibility displays (rear-facing, back-facing for example), various image capturing devices operable to record the journey/ride/walk, tracking the route using location tracking devices such as satellite navigation systems, provide social connectivity to share and communicate with friends and other riders, for example, emergency monitoring services to support any unexpected conditions and provide help services.

Additionally, the personal security platform is operable to communicate a signal message to the drone to trigger a sound broadcasting function in the drone so that, in case of emergency, the drone can activate a voice from loudspeakers to scare off threats.

It is noted that, accordingly, the wearable technology application may be provided with high visibility turn signals, cameras to record a journey as well as connectivity to track a route, friends and biometrics. Selected features of the system may include: LED Turn Signals and Brake Lights; satellite navigation, location tracking and mapping to assist navigation and to track other riders; social connectivity to allow connecting with friends and other riders; image capturing devices to record a journey (photos and videos); and further, when necessary provide emergency monitoring service.

The platform, as such may include: various type of image capturing devices and cameras (front, back, side), microphone and call buttons, LED turning signals, brake lights, reflective material, location tracker and navigation system, social and emergency connectivity via an associated software application running on a mobile communication device.

Accordingly, the smart LED indicator may include: High Visibility turn signals; brake lights and running lights; motion control sensors; auto-activated brake lights; satellite navigational mapping may automatically activate turn signals which may provide various safety and security measures of high visibility and safety; hands free activation possibly via voice activated controls using an integrated microphone; broadcast current location; and emergency mode may be triggered by a motion controlled accident sensor, for example, and may automatically engage hazard lights, camera, emergency calls.

Additionally, the integration of a front and back cameras may allow features including: recording the road, monitoring around, hands free activation, high quality image recording and well positioned point of view.

Furthermore, an emergency alert feature may be triggered by a push button or sensor input for example indicating sudden stop/falling.

An automatic notification interface may be provided for communication with autonomous vehicles. It is noted that such an interface may make the user visible to self-driving automobiles and the like.

A live video feed function may be triggered in the drone by key events (optionally, based upon signal commands received from the user) such as an impact, a fall or an attack. Accordingly, the drone can send a live video feed to a desired address, possibly to a particular telephone number or e mail address.

The personal security platform may provide a list of benefits, such as capturing adventures; sharing with friends online; storing captured images in the cloud; documenting emergency and dangerous situations, including attacks, harassments and the like; using a motion controlled accident sensor to automatically engages hazard lights; using cameras and emergency calls.

It is a particular feature of embodiments that a voice sensitive microphone may be incorporated into the wearable system. The features of the microphone may include: voice activated and on/off call button; hands free activation; Bluetooth connectivity with smartphones.

Furthermore, executing an appropriate software application may provide additional benefits including: calling for emergency help activated by voice' including provide full functionality activation by voice; communicating with friends and narrating the journey.

The system may feature satellite navigation, mapping and tracking, providing various benefits including: people tracking allowing one to keep their children safe, knowing always their location; providing self-tracking knowledge (know where you are and where you are going to); finding best routes and point of interest; finding ride/jogging times and distances; tracking friend in real time; and archiving routes, speed and distance data.

Accordingly particular benefits supported by the personal security platform include: satellite navigation mapping via smartphone application; hands free voice activation; saving favorite destinations and routes; tracking other riders; and tracking of children by their parents.

Additionally, social connectivity features of the platform may include: real-time social connectivity; hands free activation; voice navigation; and tapping into the social community.

It will be appreciated that these features provide still further benefits such as: connecting with friends online all along during a journey; sharing of rides with photos, video, voice recordings, tipping of great rides and destinations; and connecting directly to social network such as Facebook and favorites social media applications.

The platform may also offer twenty-four hour emergency monitoring service features, including: emergency call services; tracking services of the ride; motion control sensor auto-activated in an emergency mode to engage automatically hazard lights, brakes, cameras and emergency calls and alarms; providing pre-programmed emergency call dials such as 911 and the like.

The Associated software application may provide still further features, including: simple, smart, intuitive hands free activation of all features; supporting of watches of Apple iOS, Android and other smart watches; Bluetooth connectivity; free download for all updates; providing premium features with subscription; enabling GPS mapping, tracking and social connectivity; health reporting with tracking and archiving; providing routes, speeds and distances; saving and sharing of favorite routes; providing photos, videos, tipping of destinations; social connectivity and community.

It is noted that a children notification feature may be supported for example while a student is with a school bus. The driver may receive indications that a passenger (a student) is waiting at a specific bus stop.

Additionally, the monitoring option may be configurable by a parent/supervisor to a specific set of parameters. If the child/user using the software application, the parent or the supervisor may configure the parameters such that if changed or if the child strays outside this set of parameters, a notification will be transmitted to increase safety and security.

Furthermore, if the child/user inputs into the software application a destination setting, the Parent/Supervisor may be notified of the chosen destination

It is noted that in some embodiments a variety of further functions and systems may be enabled, including: a “Visible Me” function may allow the following:
A third party location tracking agents may connect with the software application so they will be able to notify a driver that a rider is approaching or near.
At the same time the biker may get a notification that a car is approaching
These features may be activated while a car is going above a certain threshold speed, say 20 MPH or more. The speed feature may be disabled in specific area such as city center, where bike riders are assumed to be close to city traffic, thus alerting and notifications are also disabled.
When a driver is signaling with his indicator, right or left, and a biker is behind, the software application in conjunction with the location tracking agent of the car, may notify the car that a biker is behind.
It is further noted that a microprocessor may be incorporated into the wearable item and will process all relevant data and communication, the microphone on the wearable item and the earpiece will continue to communicate if the officer loses his phone or walkie-talkie for example, a police officer, firefighter, correction officer and other security guards, if they were to fall or some unnatural movement, (such as falling from a bike) which will be sensed and notification will be sent to the pre-programmed number or the back office or headquarters of the monitoring station.
While wearing the wearable item, with the microprocessor, if a police officer un-clips his gun from the holster, it will immediately notify the back office or headquarters of the monitoring station.
The back office will be able to remotely turn on the wearable item camera and/or the microphone and other communications on the wearable item.

Moreover, the platform may be configured such that there is an emergency button on the wearable item itself that can be pushed to call for help.

Additionally, one should appreciate that:
(A) In known historically dangerous intersections and roads, the LED lights, will automatically light up to ensure visibility.
(B) In known historically dangerous intersections and roads, the camera will automatically turn on for safety purposes.
(C) A drone will be able to follow the user automatically, possibly via the app
(D) The app will be configurable to automatically notify a school bus driver, of a child's bus stop, that the child was picked up at the stop and dropped off at the school. This can be via the software application, if a child does not have a smartphone, there will be a separate device with the vest.

The personal security platform may be operable in a monitoring mode reading input from the environment automatically via the various platform component such as location tracker module, motion sensors image capturing device and the like. The platform may be in communication with various protecting agents which may be configured to be in a listening mode, waiting for an activation signal from the personal security platform either for a continuous tracking of the user or activation of a specific action.

If a signal command is received such an activation signal or location update, the protecting agent is configured to respond accordingly and further may provide a response signal of confirmation.

When in monitoring mode, the personal security platform may be configured to periodically transfer location command signals to allow for tracking of the user by the UAV, for example.

As detailed below, various command signals may be used with the platform. The command signals may be generated by a signal command generating unit of the platform in response to automatic analysis of the monitored input or in response to actual commands of the user initiated manually (pressing a button, for example) or by voice commands.

Reference is now made to FIG. 6A, there is provided a system architecture of the personal security platform, which is generally indicated at 200, the architecture presents the various system components of the personal security platform. The system architecture 200 comprises a wearable item 210 operable to control at least one protecting agent such as a first protecting agent 212, a second protecting agent 214 and a third protecting agent 216.

It is noted that the protecting agents 212, 214 and 216 are presented as an example only and is intended to specify one or more protecting agents.

The wearable item 210 is configured to be worn by the user or attached to his garment, and comprises a micro-processor 230, a command signal generating unit 240 and a communication interface 250.

The micro-processor 230 is configured to execute a software application module comprising a set of component modules such as an image module 232 configured to manage a protecting agent of an image capturing device 272, a sensor module 234 configured to manage a protecting agent of at least one motion sensor 274, a display module 236 configured to manage a protecting agent of at least one display.

The protecting agent of the display 276 may include a rear-facing display attached to the back of the user or a front-facing display attached to the user at the front or both.

The protecting agent of the motion sensor 274 is configured to determine at least one motion parameter associated with the user and may be one or more of an accelerometer, a tilt sensor and a proximity sensor.

The protecting agent of the image capturing device 272 may include at least one camera that may be selected from a group of cameras consisting of a front camera, a back camera, a side camera and combinations thereof.

The command signal generating unit 240 is configured to generate at least one command signal to allow communicating via said communication interface for controlling at least one protecting agent such as a protecting agent 212, a protecting agent 214 and a protecting agent 216 (using communication channels “A”, “B” and C″ respectively).

It is noted that the communication interface 250 is further operable to enable communication with at least one remote server.

The personal platform further comprises a location tracker module 260 for tracking a location of the user, and the location tracker module is configured to provide location based data.

Optionally, the wearable item 220 comprises the location tracker module 260. Additionally, the wearable item 220 is configured to retrieve map data from an external source, based on data from the location tracking module 260.

Optionally, the location tracker module 260 comprises a satellite navigation system. As appropriate, the location tracker module 260 is configured to communicate with an external satellite navigation system.

It is noted that a particular feature of the current disclosure is that at least one of the personal protecting agent (212, 214, 216) comprises an unmanned aerial vehicle (UAV), and that the software application module is configured to communicate with at least one of the unmanned aerial vehicle (UAV) such that the software application module controls the UAV.

It is noted that the protecting agent may further be selected from one or more of: a rear-facing display, front-facing display, at least one motion sensor and at least image capturing device.

Additionally, the emergency feature may be operable by voice or activated loudly via a speaker to announce, for example, “YOU HAVE BEEN RECORDED” so as to deter a threat. Optionally, the emergency feature may be initiated by a user activated push button or the like.

Reference is now made to FIG. 6B, there is provided an activation mechanism of the personal security platform, which is generally indicated at 300, the activation mechanism 300 configured to provide automatic activation methods, manual activation methods and voice activation. The activation mechanism 300 comprises a command signal generating unit 310 operable to receive input from various components via an input interface 312 and further generate appropriate output signal commands to operate the security platform accordingly.

The personal security platform is operable to receive input from various platform components and agents such as the Location Tracker (FIG. 6B, item 260), image Capturing Devices (FIG. 6B, item 272), Motions Sensors (FIG. 6B, item 274), displays (FIG. 6B, item 276) and the like in order to generate the necessary automatic commands. Additionally or alternatively, the personal security platform is further operable to drive various platform functions manually or read voice enabled commands to generate the desired signal commands. Thus, the command signal generating unit 310 is configured to read manual input from manual components such as a push button 320 (via input “A”), a button 330 (via input “B”) or similar other manual components such as pull cords (not shown) and the like. The command signal generating unit 310 may be further configured to read vocal commands via a microphone 340 (via input “C”) associated with the personal security platform and activate the platform as appropriate. Optionally, the voice activation of the security platform may include a pre-configured set of voice commands.

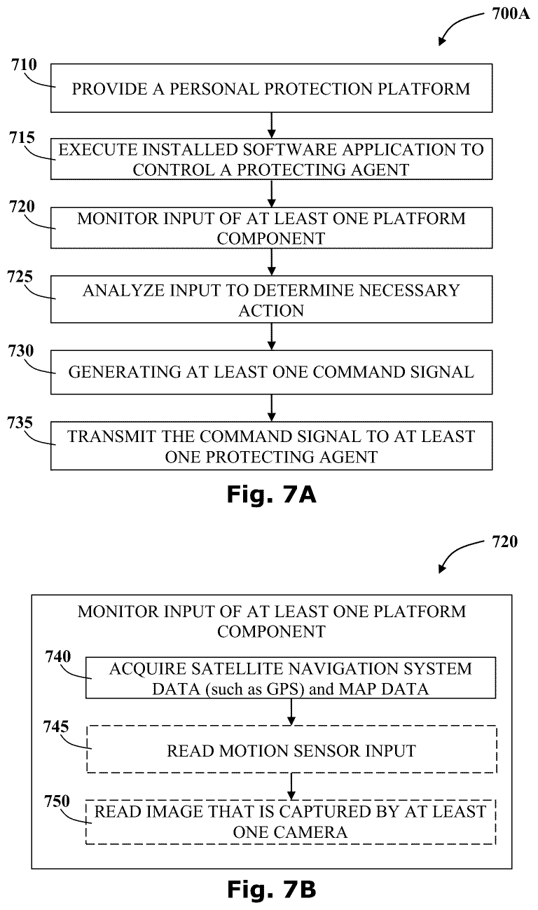

As illustrated in FIG. 7A, a method 700A may be provided, whereby the personal security platform 700A is operable to control at least one protecting agent.

In step 710 of the method 700A, a personal security platform for providing security measures to a user is provided, such as described hereinabove.

In step 715, the personal security platform 200 is configured execute the software application installed on the micro-processor 230 (FIG. 2) to provide the logic for controlling at least one protecting agent, thus providing the required safety and security measures to the user.

In step 720, the platform 200 monitors input received from the various platform components, relating to the current scenery thereof, from a location tracker module (FIG. 2, item 260), image module (FIG. 2, item 232) associated with captured images of at least one camera, sensor module (FIG. 2, item 234) associated with motion parameters. According to some examples, the location tracker module is integrated with the personal security platform 200. According to other examples, the location tracker module is external to the security platform 200 (such as a smartphone or a standalone location tracker module), and the platform is configured to communicate with it, inter alia to receive GPS data.

In step 725, the security platform 200 analyzes the input acquired as described in step 720 and determines the required action based on the location information provided by the location tracker, the sensor parameters and image and video data.

In step 730, the security platform 200 generates the necessary signal commands to trigger the required action. The signal commands may be generated by the signal command generating unit (FIG. 2, item 240). Alternatively, the signal commands may be generated by the micro-processor (FIG. 2, item 230).

In step 735, the security platform 200 transmits the generated signal command (as described in previous steps) to the at least one protecting agent (FIG. 2, items 212, 214, 216) or specifically to one UAV such as presented in FIG. 1A (items 120A, 120B) to execute desired control action.

As illustrated in FIG. 7B, a method 720 may be provided whereby the personal security platform 200 is operable to monitor input of at least one platform component, as indicated in FIG. 1. The platform 200 may monitor input relating to the current scenery thereof, from a location tracker module (FIG. 2, item 260), image module (FIG. 2, item 232) associated with captured images of at least one camera and sensor module (FIG. 2, item 234) associated with motion parameters.

In step 740 of the method 720, a personal security platform may acquire satellite navigation system data (such as GPS) and map data.

In step 745 of the method 720, the personal security platform 200 is operable to read input from at least one motion sensor; and

In step 750 of method 720, the personal security platform 200 is operable to read at least one captured image from at least one camera.

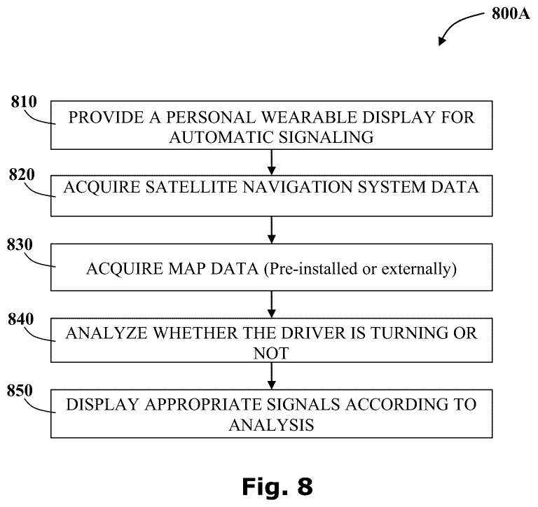

As illustrated in FIG. 8, a method 800A may be provided, whereby the platform 600A indicates a turn signal on its display 620.

In step 810 of the method 800A, a personal security platform for automatic signaling 600A is provided, such as described above with reference to FIGS. 6A and 6B. In particular, the platform 600A may be configured to acquire satellite navigation system and location data, and may comprise a display 620 with indicators 622, a controller, and one or more motion sensors, such as one or more accelerometers, one or more tilt sensors, etc.

In step 820, the platform 600A acquires data, relating to the current location thereof, from a location tracker module. According to some examples, the location tracker module is integrated with the platform 600A. According to other examples, the location tracker module is external to the platform 600A (such as a smartphone or a standalone location tracker module), and the platform is configured to communicate with it, inter alia to receive GPS data.

In step 830, the platform 600A acquires map data corresponding to the GPS data acquired in step 820. According to some examples, the platform 600A is preloaded with the map data. According to other examples, the system is configured to acquire the map data from an external source (such as a smartphone or by connecting directly to an information server, e.g., via the internet), e.g., on demand based on the GPS data.

In step 840, the platform 600A determines, based on information provided by the motion sensors thereof, whether or not the vehicle being driven by the user is turning.

As In step 850, the controller determines, based on the location information provided by the location tracker, the map data, and the information provided by the motion sensors, whether or not a turn signal should be displayed. For example, if the motion sensors indicate a turn, but the GPS and map data indicate that the user is following the topography of the road, the controller may determine that no turn signal should be displayed. If the motion sensors indicate no turn, but the GPS and map data indicate that the user is entering an exit ramp, the controller may determine that a turn signal should be displayed.

In step 860, if the controller in step 850 determined that a turn signal should be displayed, indicators 622 of the platform 600A are activated to display the appropriate signal.

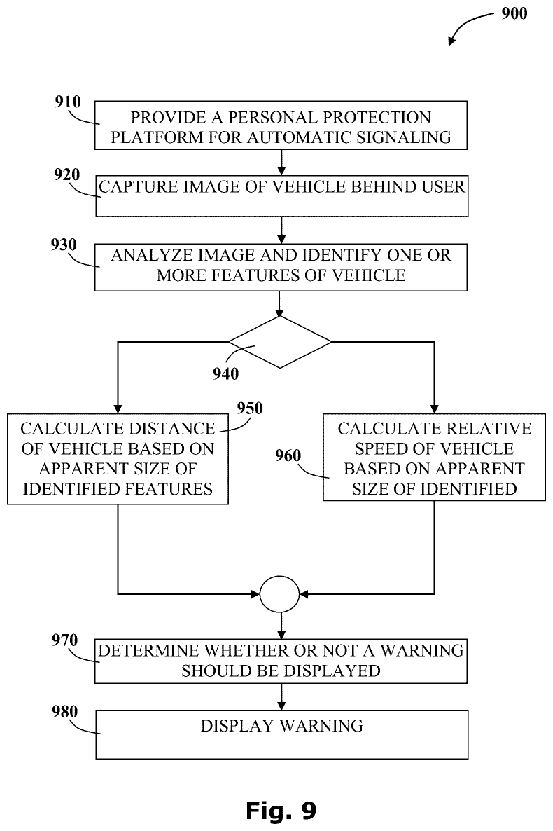

Reference is now made to FIG. 9, another method 900 may be provided, whereby the platform 600A indicates a warning to vehicles therebehind on its display 620.

In step 910 of the method 900, a platform 600A is provided, such as described above with reference to FIGS. 6A and 6B. In particular, the platform 600A may be provided with a controller, a display 620 with indicators 622, and a camera 640.

In step 920, the camera 640 captures an image of a vehicle behind the user.

In step 930, the controller analyzes the image captured by the camera, and identifies one or more features of the vehicle therebehind.

In decision step 940, the controller chooses to determine whether to assess the distance (in step 950 below) or speed (in step 960 below) of a vehicle approaching therebehind.

In step 950, the controller compares the identified features, and calculates its distance based on the apparent size thereof based on the captured image, and preloaded information relating to its actual size. For example, the controller may be preloaded with information relating to the actual size of a license plate. Information relating to the apparent size of the portion of the captured image corresponding to the license plate (such as the number of vertical and/or horizontal pixels thereof, and camera information) is used to calculate the distance the license plate would be to produce such an image.

In step 960, the controller compares the relative size of one or more of the same identified features in different frames captured by the camera 640. By comparing the change in size of these features, and taking into account the elapsed time between the captured frames, the controller calculates if the vehicle approaching from behind is accelerating, or maintaining its speed (e.g., when it should be slowing down), etc.

It will be appreciated that the method 900 may be provided without one of steps 950 and 960 (and without the decision step 940), and/or with steps 950 and 960 be performed in parallel, without departing from the scope of the presently disclosed subject matter, mutatis mutandis.

In step 970, the controller determines, based on the calculations performed in either or both of steps 950 and 960, whether a warning to vehicles therebehind should be displayed.

In step 980, if the controller in step 970 determined that a warning should be displayed, indicators 622 of the platform 600A are activated to display the appropriate signal.

In addition to the wearable devices, the display may also comprise of roadside display boards known as signages used to communicate, to convey information designed to assist the receiver with decision-making based on the information provided. The display may be a digital screen installed in a vehicle for the passengers to visualize the information. For example, a digital screen installed on the back side of the front seat and visible to the passengers on the back seats. Moreover, the display may be LED shop display boards providing information of the current offers to the passing by locals.

The advertisements may be displayed on a display device considering the number of nearby people who can actually see the advertisement to increase their visuality and relevance. The system of the present information may adopt a number of mechanisms to determine the number of people present in the vicinity of the display and the individuals actually viewing the advertisement on the display for increasing the effectiveness of the advertisements being displayed. The display may also be digital displays of sports complexes or stadiums providing offers on the tickets on the current sports. The companies may also rent their building spaces for placing displays of third parties.

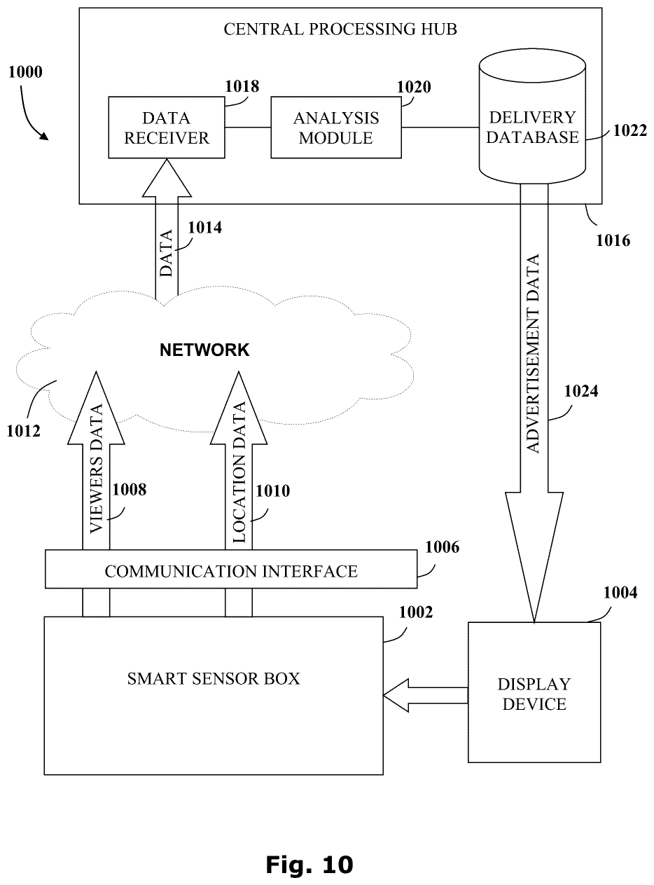

Reference is now made to FIG. 10 which illustrates a system 1000 to measure and increase the effectiveness of the advertisements on a display device 1004 using a smart sensor box 1002. The smart sensor box 1002 is a retrofittable enhancement module for monitoring viewers in the vicinity of the advertising display. The smart sensor box 1002 can be a fixed attachment on the display device 1004 or may be retrofittable to the display device 1004. Alternatively, the smart sensor box 1002 can be a part of the display device 1004. Furthermore, the smart sensor box 1002 can be attached to the display device 1004 through a wired or wireless means.

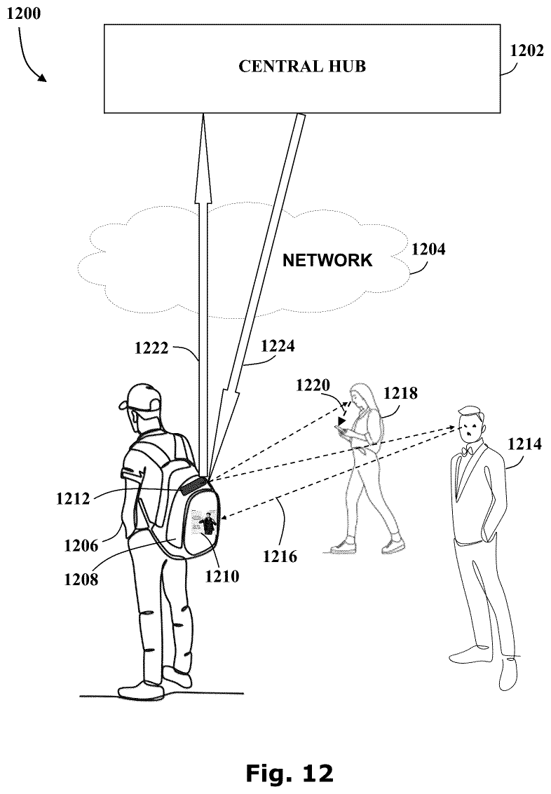

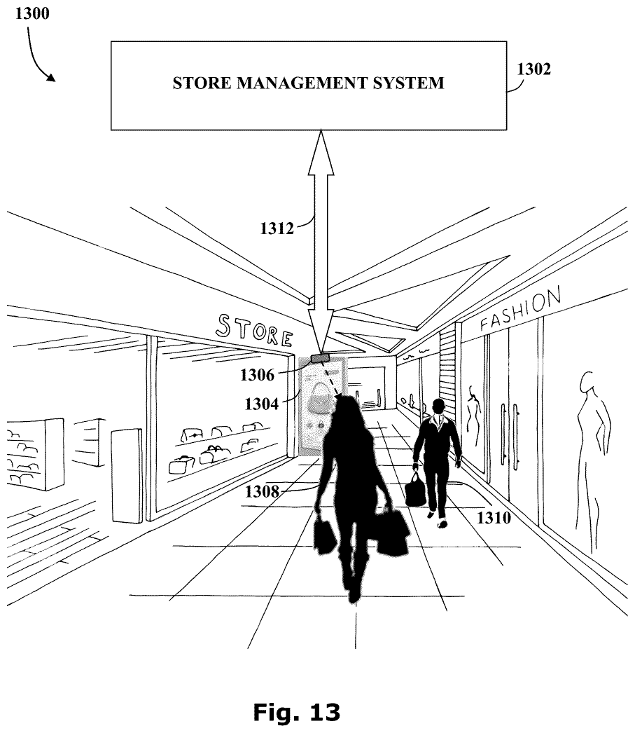

The display device 1004 can be a screen attached at the back of a bag pack of a delivery person as shown in FIG. 12. The display screen 1210 attached to the back of a delivery bag 1208 of a delivery person 1206. The smart sensor box 1212 is attached to the bag 1208 and connected to the display screen 1210 through a wired or wireless means. In an alternative embodiment shown in FIG. 13, the display screen is a billboard 1304 placed at a store in a shopping mall 1300. The smart box 1306 is attached at the top of the billboard 1304. Alternatively, the display screen can be a billboard placed in a marketplace, a roadside signage board, a fixed or portable advertisement board placed in a corporate or business unit, hospitals, cinema hall, stadium, sports complex, parking area, or any public place.

In an alternative embodiment of the invention, the display screen is also configured to display public messages, hazard warnings, announcements, etc. to a group of people or general public. The invention also caters to measure the reachability of these messages and warnings to the general public.

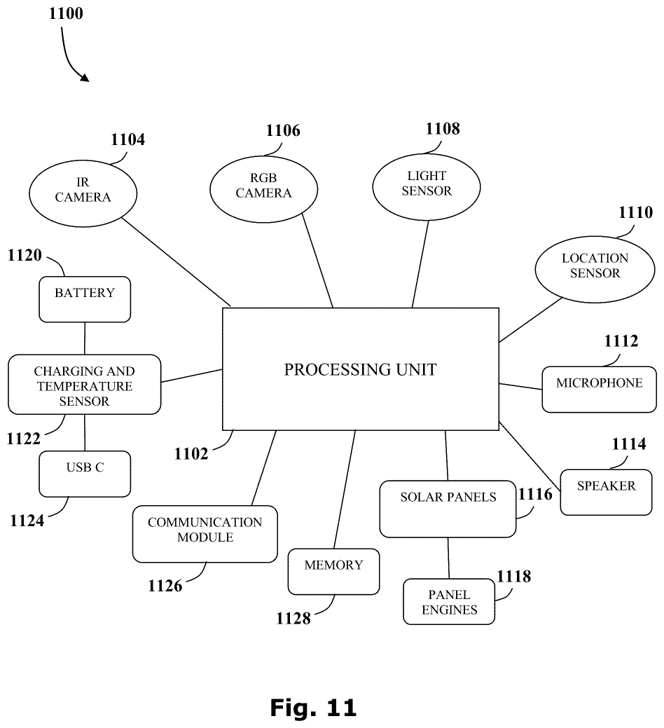

The various components of the smart sensor box 1100 are shown in FIG. 11. The sensor box 1100 comprises a processing unit 1102 which controls all the other components of the sensor box 1100 and also processes the received data. In an exemplary embodiment, the processing unit 1102 can be a Raspberry Pi 5 single board computer which is a controlling host for all the connected peripheral devices. Alternatively, the processing unit 1102 can be an embedded system executing software or firmware.

The smart sensor box 1100 may comprise one or more cameras to capture the images of nearby areas and individuals around the display screen. The camera can be 200 degrees RGB Cameras 1106 used to deliver colored images of people and objects by capturing light in red, green, and blue wavelengths (RGB). The RGB camera 1106 is equipped with a standard CMOS sensor through which the colored images of persons and objects are acquired. The cameras can also be Infrared cameras 1104 used to capture images during night time or places where intensity of light is low. The smart sensor box 1100 may comprise one or more of any of the cameras for capturing the images. The sensor box 1100 may also comprise a light sensor 1108 used to measure the intensity of light in the vicinity of the display device. The processing unit 1102 will activate the cameras based on the intensity of light measured by the light sensor 1108. For example, in case of darkness the light sensor 1108 will provide the information to the processing unit 1102 which will activate the Infrared cameras 1104 for capturing the vicinity images. The light sensor 1108 may also comprise day and night modes which can be manually selected or adjusted automatically. A location sensor 1110 is provided to capture the location of the sensor box 1100 and the display screen on which advertisement is being presented. The location sensor 1110 may be based on any Global navigation satellite system (GNSS) such as Global Positioning System (GPS), Global Navigation Satellite System (GLONASS), BeiDou Navigation Satellite System (BDS), Galileo, Indian Regional Navigation Satellite System (IRNSS), Quasi-Zenith Satellite System (QZSS) to capture the location information. Alternatively, the location sensor may be a position sensor that detects a person or object's position. Any known location sensor may be used in the sensor box 1100 without limiting the scope of the invention. The sensor box 1100 may also comprise a microphone 1112 and a speaker 1114 to enable a person carrying the sensor box 1100 with the display screen to exchange instructions and information with a central office or a third party.

The sensor box 1110 may also comprise solar panels 1116 to provide power to the sensor box 1110 for operating the various components and charge the battery 1120. The battery 1120 is connected to a charging and temperature sensor 1122 which monitors the remaining battery 1120. The sensor 1122 also monitors the battery 1120 condition like its health, current leakage, rusting and its operating temperature. In case of any detected deviation from the standard parameters, a notification is provided to either to the person carrying the smart box 1110 with the display screen or to a third party responsible for maintaining the smart box 1110. The smart box 1110 may also comprise a physical sim or USB port 1124 which may be connected to update the processing unit 1102 software.

The smart box 1110 may also comprise a communication module 1126 for communicating with the display screen and a central processing hub 1016 as illustrated in FIG. 10. The smart box 1110 may connect with the display screen via a wired or wireless connection. In an exemplary embodiment, the communication module 1126 comprises a Bluetooth connection for connecting with the display screen. The communication module 1126 may also comprise network interface encompassing wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). The communication module 1126 may also comprise interface for connecting with a cloud network. The smart box 1100 may also comprise a memory 1128 to store the images captured by the cameras and the data processed by the processing unit 1102.

The above-mentioned components of the smart sensor box 1100 are exemplary in nature and should not limit the scope of the invention. The smart sensor box 1100 may contain one or more of the components as required for the invention. Further, the smart sensor box 1100 may also contain additional components not disclosed herein.

Referring back to FIG. 10, the system 1000 comprises a communication interface 1006 which communicates the viewers data 1008 and the display device 1004 location data 1010 from the smart box 1002 to the central processing hub 1016 via a network 1012. The viewers data 1008 and the location data 1010 may be transmitted separately or as a consolidated data 1014 to the hub 1016. The communication interface 1006 may be a separate component from the smart box 1002 or may be a part of it as the communication module 1126 (shown in FIG. 11).

The viewers data 1008 may comprise the data pertaining to the people in the vicinity of the display device 1004. For example, the smart sensor box 1002 may capture the images of the people through the RGB camera 1106 or the IR camera 1104. The captured images of the people are processed by the processing unit 1102 to generate valuable data. The processing unit 1102 is configured to distinguish between the human beings from the animals present in the captured images using any known face recognition technology. The processing unit 1102 may further be configured to identify physical profiles of the human beings, like gender, age, physique, clothing pattern, spectacles, shoes, hairstyles, carried items, etc. from the images. The face recognition technology may also identify the individuals and pick up their stored profiles. The images are also used to identify the number of people in the vicinity of the display device 1004.

The processing unit 1102 is also configured to monitor the engagement of individuals with the display device 1004 by identifying the individuals viewing the advertisement running on the display device 1004 and capturing their images. These individuals are identified through the installed cameras 1104, 1006 of the smart box 1100. As illustrated in FIG. 12, the smart box 1212 camera (not shown) capture images of the nearby individuals 1214 and 1218 by focusing on the line of their eyesight 1216 and 1220. The images are processed by the processing unit 1102 to identify the individual 1214 looking at the display device 1210 while the individual 1220 not looking at the display device 1210. The processing unit 1102 may also be configured to determine the facial expressions of the individuals while viewing the advertisement on the display device 1210 to determine their interest pattern in the advertised product. For example, a kid watching the advertisement of a chocolate may have the expression of excitement to grab it. Similarly, a woman might be excited to view an advertised dress, while an elderly person, although looking at the display, might not show any expression of interest. The processing unit 1102 may also determine the duration of advertisement watched by the individuals, any specific portion of the advertisement watched or skipped by the individuals, etc. The captured images and processed data are stored in the memory 1128 of the smart box 1100.

The processing unit 1102 may employ any of the known methods for identification of the human beings, their attributes and expressions from the captured images. As a non-limiting example, the processing unit 1102 may use a machine learning algorithm such as such as deep neural networks, deep belief networks, deep reinforcement learning, recurrent neural networks, convolutional neural networks and Transformers to analyze the images.

The processing unit 1102 may also be trained to identify the human beings and their attributes using Machine Learning (ML) algorithms. The processing unit 1102 may employ any of the known ML algorithm as per the requirement. The algorithm can be a Supervised Learning algorithm which consists of a target/outcome variable (or dependent variable) which is to be predicted from a given set of predictors (independent variables). Exemplary Supervised Learning algorithms include Regression, Decision Tree, Random Forest, KNN, Logistic Regression etc. Alternatively, algorithm can be a Reinforcement Learning algorithm using which the machine is trained to make specific decisions. Exemplary Reinforcement Learning algorithm includes Markov Decision Process.

The location data 1010 captured by the location sensor 1110 is used to identify the area where the display device 1004 is located. For example, the location sensor 1110 may identify the area as a shopping mall, a hospital, a sports complex, a parking area, a corporate hub, a residential society, a road, an educational institution, a marketplace, etc.

Any nearby person having an application installed in their mobile phones of the product/service being advertised may automatically receive a notification of the promotional offers. As an example, a coupon code in form of a QR code may be triggered on the mobile phone of the nearby person to avail the offer. The coupon may be scaled up depending on the time of day or if a customer has not activated his app recently to entice them to frequent, by offering a special discount or coupon or other. Alternatively, the person may also log in to their installed applications to see if there any codes or coupons or special offers, discounts, being offered by the local establishments. Further, the offers being displayed can also be availed from the display boards or wearable display of the salesperson. For example, the display boards or wearable display may provide a QR code which the person may scan with his mobile phone to avail the offer. The person availing the offers may further be presented targeted ads aimed at his profile specifications and/or his current location. The promotional offers may be provided to the smart sensor box 1002 by the central processing hub 1016.

The central processing hub 1016 may be a server system of an advertisement company which is interested to measure the effectiveness of their advertisements. Alternatively, the hub 1016 may be third party server providing billboard service to the advertisement companies. Furthermore, the hub 1016 may be government or privately owned servers. Also, the hub 1016 may be a management system of the place where the display device is located. FIG. 12 shows the central hub 1202 as an advertisement company or third-party server. FIG. 13 shows the hub as a store management system 1302 of a shopping complex. Similarly, the hub 1016 can be a management system of a marketplace, a road, a cinema hall, a mall, a stadium, a sports complex, a business complex, a parking area, a hospital and any other public place.

The data 1014 from the smart box 1002 is received by a data receiver 1018 of the hub 1016. The data receiver 1018 may comprise an antenna to receive the data 1014. The data receiver 1018 transmits the data 1014 to an analysis module 1020 which analyze the data 1014 to determine the effectiveness of the advertisement being displayed on the display device 1004.

In an alternative embodiment of the invention, the processing of the captured images and the location data is done by the analysis module 1020 of the central processing hub 1016 instead of the processing unit 1102 of the smart box 1100. In such a case, the image data captured by the cameras 1104 and 1106 and the location data from the location sensor 1110 are transmitted from the sensor box 1002 to the hub 1016 without processing. The analysis module 1020 processes the received data to identify the number of people in the vicinity of the display device 1004, the individuals who are actually looking at the advertisement on the display device 1004 and their profiles. The location data is also processed at the analysis module 1020 to identify the type of location where the display device 1004 is located. The purchase of the products from the promotional offer notifications sent on the nearby individuals is also determined by the analysis module 1020.

The processed viewers data, purchase data and the location data are used by the analysis module 1020 to determine the effectiveness of the advertisement on the display device 1004. For example, the analysis module 1020 may determine a percentage of the individuals looking at the advertisement on the display device 1004 with the total number of people in the vicinity area. The analysis may further be enhanced from the facial expression of the individuals looking at the advertisement. Furthermore, the analysis module 1020 may also determine the purchase of the displayed product in the advertisement from the shops or sales terminals in the vicinity of the display device 1004. The analysis module 1020 may also determine the click through rates from the mobile devices of the nearby individuals to purchase or check the displayed product from the promotional offers. In case, the individuals are identified from the captured images, their purchase pattern can be correlated with the displayed product.

All the analyzed data is then used to provide metrics for a costing function of the advertisement. This involves quantifying the costs associated with running the advertisement on the display device 1004 and revenue generated from the instant and future product purchase. The costing function may be used by the product company to determine different business parameters to know the effectiveness of their ad spending. For example, the business parameters may involve calculating conversion rate optimization, average cost-per-acquisition, engagement rate, click-through rate, cost per conversion, etc. The product company may use any of these parameters or any additional known parameter to determine the effectiveness of their ad spending.

In another exemplary embodiment, the display device 1004 may display a warning message, for example, of heavy rain in the nearby area based on the data received from the meteorological department. The analysis module 1020 may determine the number of people who viewed the message on the display device 1004. The analysis module 1020 may determine the effectiveness of the message by correlating the traffic condition on the nearby roads. It might compare the current traffic condition with the previous data to measure the people response.

The processed viewers data and the location data are stored in the delivery database 1022 of the hub 1016. The delivery database 1022 may also store the captured images and the location data received from the smart box 1002. The costing function and other determined business parameters may also be stored in the delivery database 1022.

In yet another embodiment of the invention, the processing of the viewers data and the location data is done at a third-party computing device (not shown) relieving the smart sensor box 1002 and the central hub 1016 of the intense processing. Furthermore, the determination of costing function and other business parameters may be done at the third-party computing device.

The analysis module 1020 may provide feedback to the display device in form of advertisement data 1024 to either continue with the running advertisement or change it in accordance with the individual profiles. The feedback is provided based on the costing function and the determined business parameters. The displayed advertisement is changed if the generated costing function is not in accordance with the expected results. For example, if very less individuals are actually looking at the advertisement or it is not being converted to actual purchase, the advertisement is updated according to the captured profile of the individuals in the vicinity. The display device 1004 will then present the advertisement 1024 received from the delivery database 1022. The delivery database 1022 may also provide feedback in form of the duration for running the current ad and then changing it accordingly. For example, the advertisement may be updated according to the day of the week or time of the day. An advertisement on a billboard near a school will display advertisement targeting kids during the afternoon when the school gets over and children are returning back home. During other time of the day, the same ad may not be effective.

In an alternative embodiment, the generated costing function and business parameters are sent to an advertising server (not shown) which provides the updated advertisement data back to the hub 1016 and stored in the delivery database 1022. The delivery database 1022 then provides the advertisement data 1024 to the display device 1004.

FIG. 12 illustrates an exemplary marketplace area with the display device 1210 attached on the back of the bag pack 1208 of a sales person 1206. The smart sensor box 1212 is attached to the bag pack 1208. The smart box 1212 capture the images of the nearby individuals who are actually looking at the advertisement being displayed on the display device 1210. The captured data 1222 is transferred to the central hub 1202 which might be a remotely located server or a cloud server through the network 1204. The analysis module (not shown) of the central hub 1202 will process the data and sends the feedback 1224 to the smart box 1212 which either continues the current advertisement on the display device 1210 or change it.

FIG. 13 illustrated an exemplary shopping mall area 1300 with the display device 1304 placed outside an women accessory store. The display device shows the advertisement of the handbags available in the store. The smart sensor box 1306 attached on the top of the display device 1304 captures the image of a woman 1308 who is looking at the display 1304. The smart sensor box 1306 is in communication with a store management system 1302 which processes the data and provide feedback to the sensor box 1306 for displaying the ad. The store management system 1302 may be a centralized server operated by the shopping mall 1300 or any third-party.

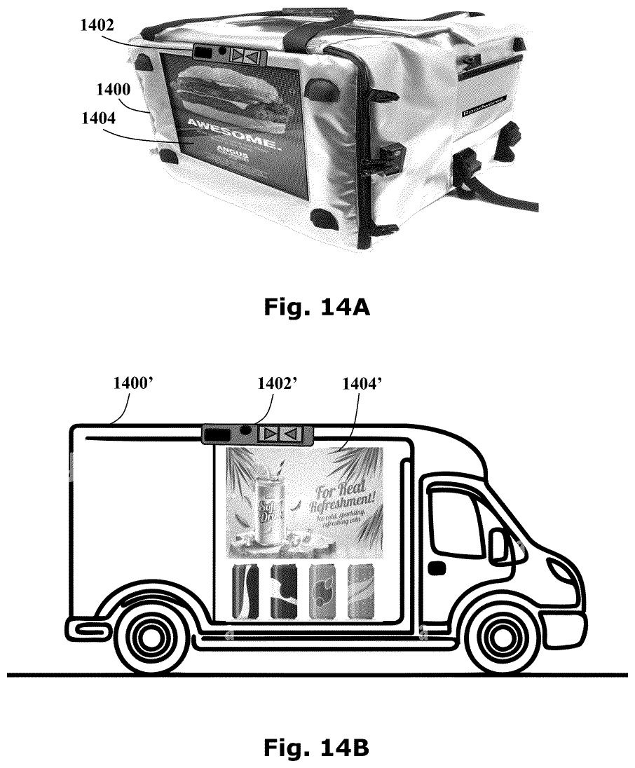

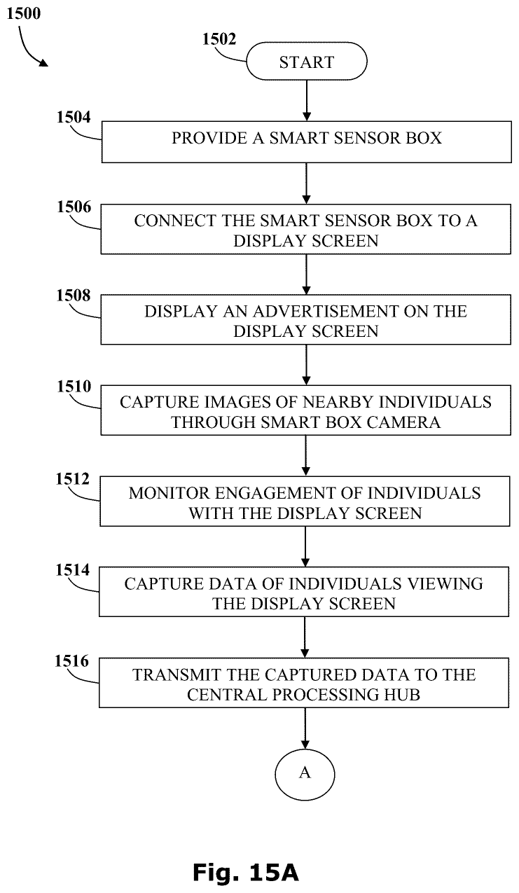

FIG. 14A illustrates the display device 1404 on the back of a bag pack 1400 with the smart sensor box 1402 attached to the bag pack 1400. FIG. 14B illustrates the display device 1404′ on a vehicle 1400′ with the smart sensor box 1402′ attached to the vehicle 1400′.

It should be noted that the above-mentioned display devices and the attachment of smart sensor box are exemplary in nature and should not limit the scope of the invention.

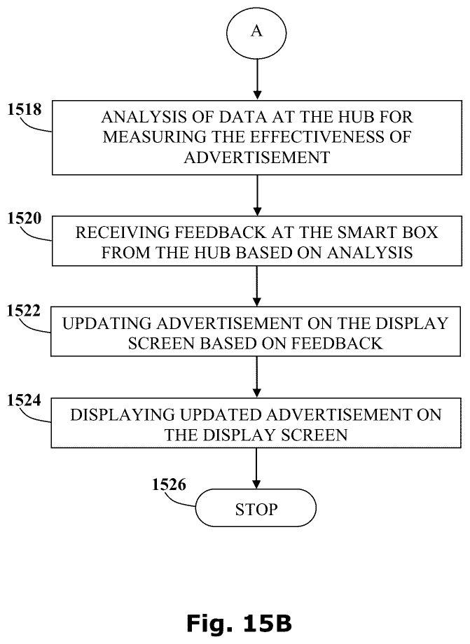

Reference is now made to FIGS. 15A and B which provide a flowchart illustrating a method for measuring the effectiveness of advertisements and promotional offers on a display. The process starts at step 1502 and a smart sensor box is provided at step 1504. The smart sensor box may comprise one or more of the components as shown in FIG. 11. At step 1506, the smart sensor box is attached to a display screen which displays advertisements and promotional offers. The smart sensor box may be a part of the display screen and attached through internal connections. Alternatively, the smart sensor box is a separate component and attached to the display screen through wired or wireless means. The smart sensor box may be detachably attached to a platform holding the display screen, such as a bag pack, a billboard, a digital display board, etc.

The display screen and the smart box are placed in a public area such as a marketplace, a road, a cinema hall, a mall, a stadium, a sports complex, a business complex, a parking area, a hospital and any other public place. At step 1508, an advertisement or a promotional offer is displayed on the display screen. The smart box camera captures the images of the vicinity area and the individuals in the vicinity at step 1510. The location sensor of the smart box also captures the location of its placement. At step 1512, the processing unit of the smart box monitors the engagement of the individuals with the display screen by identifying the individuals viewing the advertisement on the display screen and the individuals not looking at the display screen. At step 1514, the processing unit capture data of the individuals viewing the display screen. The processing unit may further be configured to identify physical profiles of the human beings, like gender, age, physique, clothing pattern, spectacles, shoes, hairstyles, carried items, etc. from the images. The face recognition technology may also identify the individuals and pick up their stored profiles. The images are also used to identify the number of people in the vicinity of the display screen.

At step 1516, the captured data is transmitted by the smart box to the central processing hub. The analysis module of the processing hub analysis the data to measure effectiveness of the advertisement being displayed on the display screen. In an exemplary embodiment, the analyzed data is used to provide metrics for a costing function of the advertisement. This involves quantifying the costs associated with running the advertisement on the display screen and revenue generated from the instant and future product purchase. The costing function may be used by the product company to determine different business parameters to know the effectiveness of their ad spending. For example, the business parameters may involve calculating conversion rate optimization, average cost-per-acquisition, engagement rate, click-through rate, cost per conversion, etc. The product company may use any of these parameters or any additional known parameter to determine the effectiveness of their ad spending.

At step 1520, the smart box receives feedback from the analysis module of the hub for the running advertisement. Based on the feedback, the smart box may continue with the running advertisement or update a new ad at step 1522. The updated ad is displayed on the display screen for the specified duration at step 1524. The process stops at step 1526.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention.

Additionally, the various embodiments set forth hereinabove are described in term of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter includes both combinations and sub combinations of the various features described hereinabove as well as variations and modifications thereof, which would occur to persons skilled in the art upon reading the foregoing description.

What is claimed is:

1. A device for measuring the effectiveness of advertisement being displayed on a display screen placed in a public area, wherein the device is connected to the display screen, the device comprising:
one or more image capturing devices configured to capture images of the vicinity area of the display screen and the individuals in the vicinity area;
one or more location sensors configured to capture location of the display screen;
a processing unit configured to process the data captured by the image capturing devices and the location sensors; and
a communication interface configured to transmit the processed data to a central hub via a network and receive feedback from the central hub,
wherein the processing unit identifies the individuals viewing the advertisement on the display screen and generate their profiles,
wherein the central hub receives and analyses the processed data for measuring the effectiveness of the advertisement and provides feedback to the device for updating the advertisement on the display screen.

2. The device of claim 1, wherein the display screen and the device are connected at the back of a bag pack of a delivery person.

3. The device of claim 1, wherein the display screen and the device are connected at a billboard or a digital display board.

4. The device of claim 1, wherein the device and the display screen are connected via wired or wireless medium.

5. The device of claim 1, wherein the display screen is also configured to display public messages, hazard warnings or announcements to a group of people.

6. The device of claim 1, wherein the image capturing devices is selected from RGB cameras and Infrared cameras as well as combinations thereof.

7. The device of claim 1 further comprises a light sensor configured to measure the intensity of light in the vicinity of the display screen.

8. The device of claim 1 further comprises one or more of a microphone, a speaker, solar panels, rechargeable batteries, a charging and temperature sensor and a USB port.

9. The device of claim 1, wherein the processing unit is further configured to identify the number of people in a vicinity of the display screen.

10. The device of claim 1, wherein the processing unit is further configured to determine the facial expressions of the individuals viewing the advertisement on the display screen to determine their interest pattern in an advertised product.

11. The device of claim 1, wherein the processing unit is further configured to measure the duration of advertisement watched by the individuals or any specific portion of the advertisement watched by the individuals on the display screen.

12. The device of claim 1, wherein the processing unit may be trained to identify the individuals and their attributes using Machine Learning (ML) algorithms.

13. The device of claim 1 is further configured to send promotional offers to the individuals viewing the advertisement on the display screen.

14. The device of claim 1, wherein the central hub analyses the data to determine metrics for a costing function of the advertisement based on an expenditure on displaying the advertisement and revenue generated from the display of the advertisement.

15. The device of claim 14, wherein the metrics is used to determine different business parameters associated with the advertisement.

16. The device of claim 14, wherein the updating of the advertisement on the display screen is based on the metrics.

17. A system for measuring the effectiveness of advertisement, the system comprising:
a display screen placed in a public area configured to display advertisements and promotional offers;
a smart box device detachably connected to the display screen, the smart box device comprising
one or more image capturing devices configured to capture images of the vicinity area of the display screen and the individuals in the vicinity area,
one or more location sensors configured to capture location of the display screen;
a processing unit configured to process the data captured by the image capturing devices and the location sensors, and
a communication interface; and
a central hub connected to the smart box device through a network, the central hub comprising
a data receiver configured to receive the processed data from the smart box device,
an analysis module configured to analyze the processed data for measuring the effectiveness of the advertisement being displayed on the display screen and generating feedback for updating the advertisement on the display screen, and
a delivery database configured to store the analyzed data and the generated feedback and transmitting the feedback to the display screen for running the advertisement.

18. A method for measuring the effectiveness of advertisement being displayed on a display screen placed in a public area, the method comprising:
connecting a smart box device to the display screen;
capturing images of the vicinity area of the display screen and the individuals in the vicinity area through one or more image capturing devices of the smart box device;
capturing location of the display screen through one or more location sensors of the smart box device;
monitoring engagement of individuals with the display screen by identifying the individuals viewing the advertisement being displayed on the display screen;
generating profiles of the individuals viewing the advertisement;
analyzing the engagement of individuals with the display screen and the generated profiles for measuring the effectiveness of the advertisement being displayed; and
running the advertisement on the display screen based on the measured effectiveness.

19. The method of claim 18 further comprising transmitting the engagement of individuals and the generated profiles to an analysis module of a central hub.

20. The method of claim 18 further comprising receiving feedback by the smart box device from a central hub.

21. The method of claim 18 further comprising determining metrics for a costing function of the advertisement based on an expenditure on displaying the advertisement and revenue generated from the display of the advertisement.
